(19) United States
(12) Patent Application Publication
(10) Pub. No.: US 2007/0240589 A1
(43) Pub. Date: Oct. 18, 2007

(54) Rotary Screen Printing Machine

(75) Inventor: Otto Richard Eppinger, Braeside (AU)

Correspondence Address: Connolly Bove Lodge & Hutz LLP;Suite 800, 1990 M Street, N.W., Washington, DC, 20036, US

(73) Assignee: Reefdale PTY Ltd, Braeside (AU)

(21) Appl. No.: 11/561,980

(22) Filed: Nov. 21, 2006

(30) Foreign Application Priority Data
Apr. 18, 2006 (AU) 2006901989

(51) Int. Cl. B41F 15/10

(52) U.S. Cl. 101/126; 101/115

(57) ABSTRACT

A carousel screen printing machine which includes a stationary column supporting a plurality of print heads; a rotatable carousel mounted on said column supporting a plurality of pallet support arms and drive means located at or above said carousel for indexed movement of said carousel about said stationary column. Indexation and registration is achieved using bushes on the carousel rotor to cooperate with complementary pins at an indexing station and at a registration station. The location of the motor makes the machine more stable during rotation and is easier to access. The registration and indexing system is simpler and uses fewer parts than in the prior art. In one embodiment an additional print head is used in association with a dual purpose load unload station.

This invention relates to a carousel screen printing machines particularly the kind used to screen print substrates such as textiles, garments, paper and cardboard.

### BACKGROUND TO THE INVENTION

Carousel Screen printing machines are used for screen printing of garments and utilise a plurality of fixed print heads beneath which are positioned a plurality of garment support pallets which are moveable from one print head to the next. The pallet arms radiate out from a central column which forms a rotor that rotates the pallets from one printhead to the next in a serial indexing fashion. The pallet arms are raised toward the printheads for the printing operation and are lowered for rotation to the next print head. It is necessary to index the rotation so that the pallets are rotated the required distance to lie below the print heads and then to register the pallet position with that of the screen on the print head to ensure that each colour of a multi colour screen print is in registration.

U.S. Pat. No. 4,099,460 discloses a rotary screen printing machine driven from below the turntable that rotates and carries the pallet arms to an index position and then raises a locking bar to engage a pin on the periphery of the turntable to achieve registration.

U.S. Pat. No. 4,934,263 discloses a screen printer of this type which provides a controlled indexing mechanism driven from the base of the printing machine below the turntable. Separate components are used for the indexing and registration functions.

In these prior art screen printers stability of the machines during rotation and ease of access for maintenance have been concerns.

It is an object of this invention to provide a simple and cost effective indexing and registration system for rotary screen printing machines.

### BRIEF DESCRIPTION OF THE INVENTION

To this end the present invention provides a carousel screen printing machine which includes
a) a stationary column supporting a plurality of print heads
b) a rotatable carousel mounted on said column supporting a plurality of pallet support arms
c) drive means located at or above said carousel for indexed movement of said carousel about said stationary column

The location of the drive motor at the level of the rotor and pallet arms provides a more stable machine operation, as there is no bending torque between the drive and the pallet arms which is the case with the prior art machines where the drive is located at the base of the vertical support column some distance below the rotor and pallet arms. Locating the drive at the level of the pallet arms also makes access to the drive motor easier. The drive motor is preferably mounted on the stator just above the rotor disc, with a gear box engaging the rotor disc.

In another aspect the present invention provides a carousel screen printing machine which includes
a) a stator supporting a plurality of print heads
b) a rotor supporting a plurality of pallet support arms
c) said rotor being mounted for rotation about said stator
d) drive means for said rotor located at or above the level of said rotor
e) location devices on said rotor to cooperate with a complementary location device at an indexing station and at a registration station

The indexing station and registration stations are located above the rotor disc on a frame associated with the frame supporting the fixed print heads. The location devices may be a location blade ad two rollers, a locating pin and a complementary bore, or a pivot arm in a slot. Preferably location bores with replaceable bushes are arranged around the periphery of the rotor disc to locate the centre line of the radial pallet arms with the centre line of the radial print head arms. An indexing pin resiliently urged downwards enters the bushing to complete the rotation of each index of the rotor in which one index moves each pallet too the next adjacent print head. Registration is achieved as the rotor is lifted toward the fixed frame of the print arms and a bushing engages a dependent registration pin. The indexing means may be fixed to the stator in that it does not rotate but may be arranged to be raised with the rotor disc for registration. Preferably one location system is used for locating the rotor and a second for registration in order to limit the wear on the registration bore from excess pressure during deceleration of the rotor.

Compared to the prior art indexation and registration systems the system of this invention is less expensive and simpler because the same rotor disc and bushes are used for both indexation and registration.

The drive means may be electric or pneumatic as is usual with carousel garment screen printers.

In conventional carousel screen printers there are two pallets which are used as a load and unload station and do not have corresponding printing heads. Thus in an 8 pallet machine only six stations can be used for printing or curing. The space in the stator adjacent the load and unload station contains the control panel and the associated electronics and controllers. This equipment has generally required the space occupied by two print heads. In the present invention the redesign of the stator and rotor allow for these components to be located around the stator and thus reduces the space occupied by the controller. This enables the number of printing and curing stations to be increased by the use of one pallet location as a dual purpose loading and unloading station. For most machines time taken to print or cure is long enough to allow one operator to unload a garment from the pallet and load a fresh garment.

In another aspect the present invention provides a carousel screen printing machine having a stator with a plurality of printing heads and a rotor having complementary pallets that each locate beneath a printing head upon an indexed rotation of the rotor, wherein there is one more pallet than printing heads and the space on the stator adjacent the additional pallet is occupied by a control panel. This station becomes the unload/load station where a single operator can control the machine and load the pallet with garments to be printed and unloads printed garments

### DETAILED DESCRIPTION OF THE INVENTION

A preferred embodiment of the invention will be described with reference to the drawings in which:

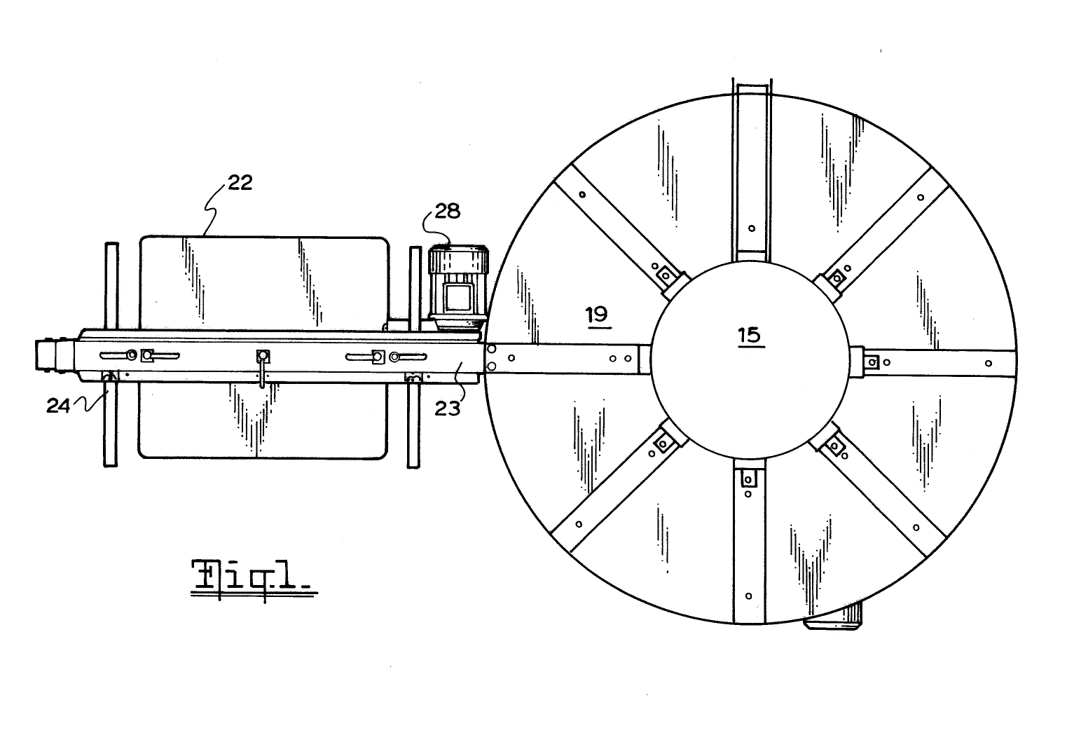

FIG. 1 is a plan view of the stator and rotor of this invention;

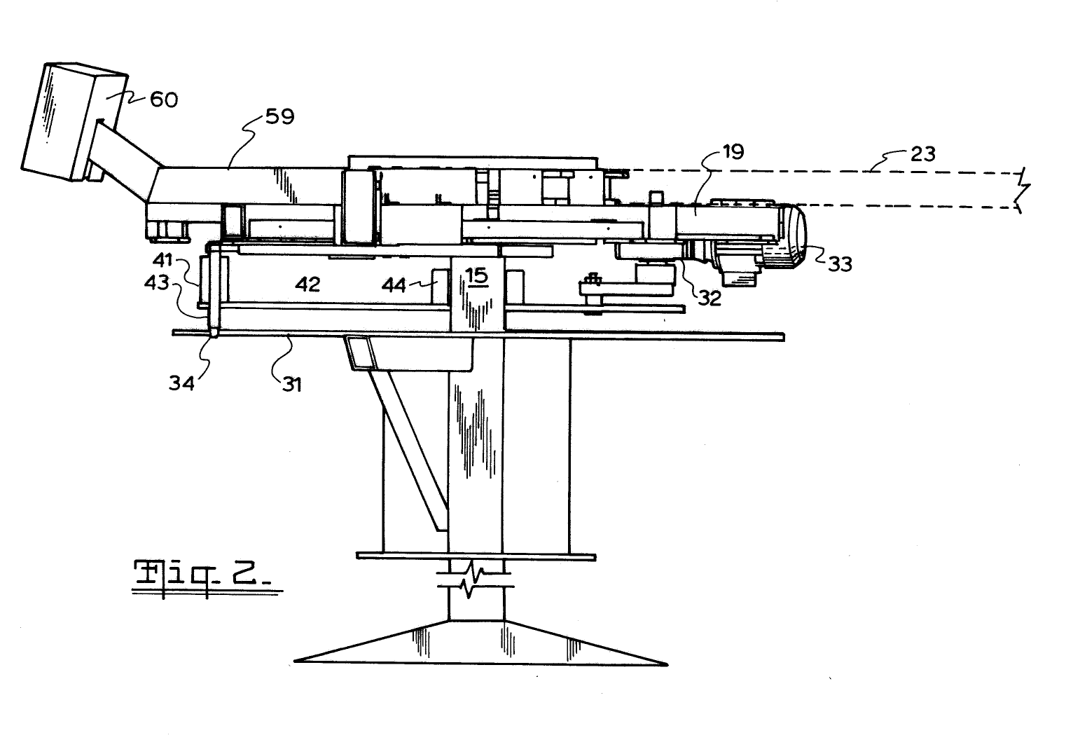

FIG. 2 is a side view of the indexing system according to this invention;

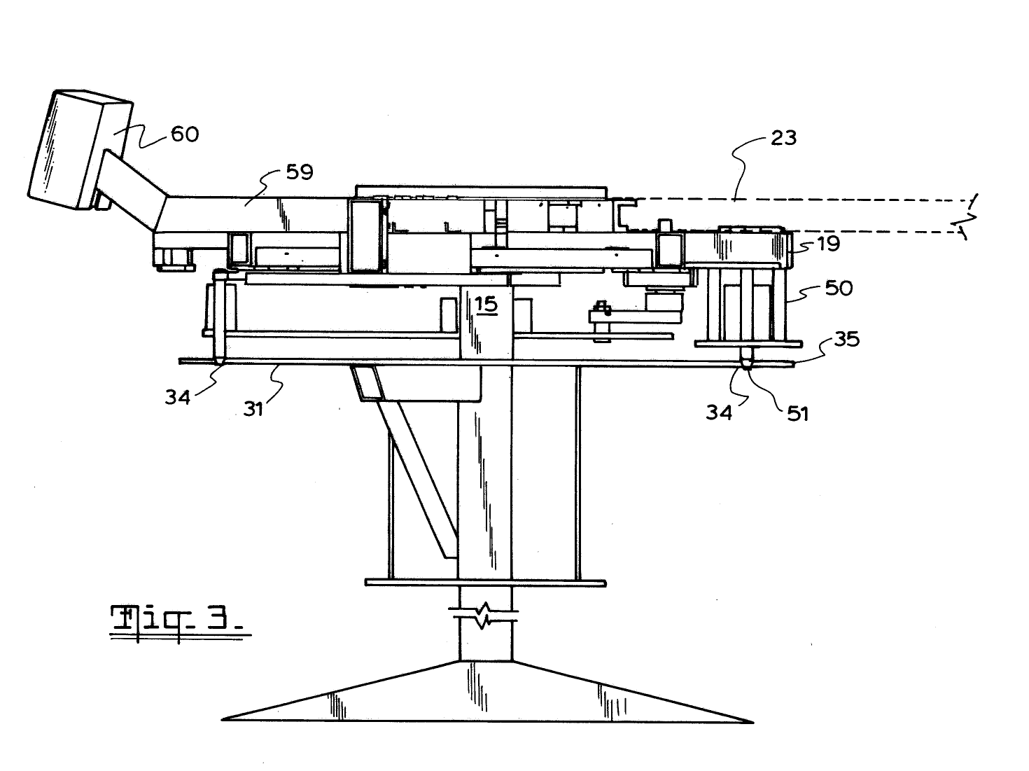

FIG. 3 is a side view of the indexing and registration system of this invention.

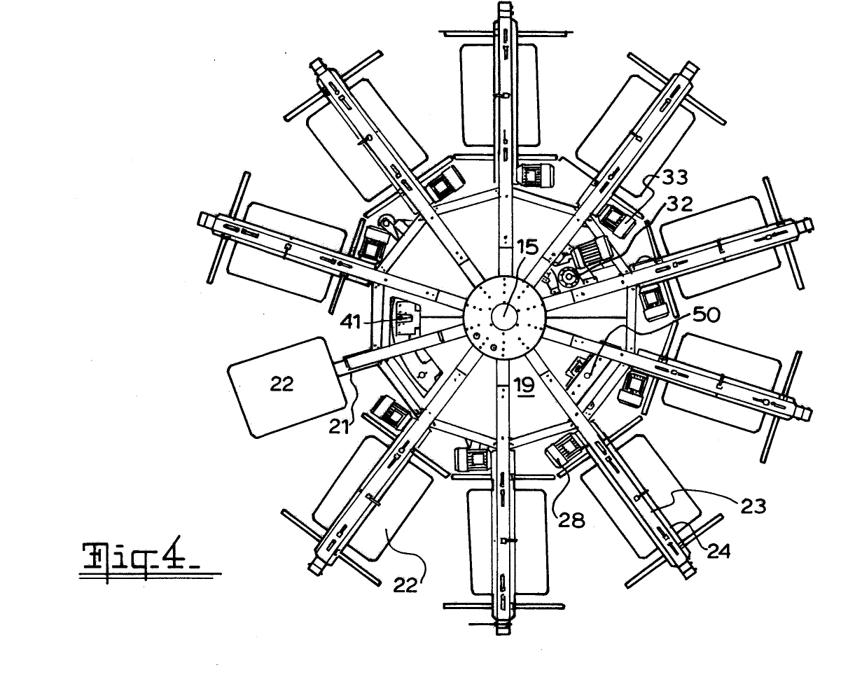

FIG. 4 is a plan view of a 10 station carousel printing machine incorporating the improvements of this invention;

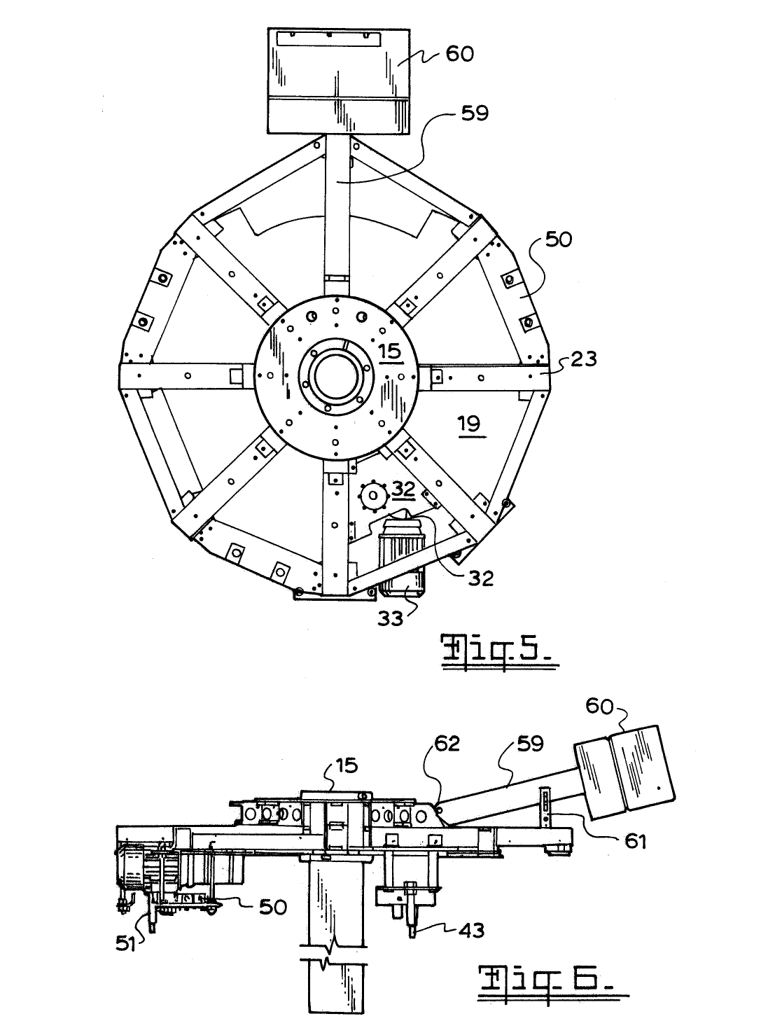

FIG. 5 is a plan view of an 8 station stator according to this invention;

FIG. 6 is a side view of the stator of FIG. 5.

In the machine illustrated the pallets rotate in an anticlockwise fashion but it is equally possible for the machine to function with clockwise rotation of the pallets. The screen printing machine comprises a rotatable set of pallet arms 21 which are mounted for rotation about a central column 15. Each pallet arm 21 carries a garment pallet 22. Garments are fitted onto the pallets.

Above the pallets are a set of print heads 24 mounted on fixed print head support arms 23 which also radiate from a stator 19 fixed to the central column 15. A print carriage motor 28 is shown in FIG. 1. Conventionally and the load station L and the unload station UL are located between the first and last printheads. A control panel is located above the stations L and UL.

As shown in FIGS. 2 and 3 the stator incorporates a control arm 59 and control station 60 located above the load and unload station. The pallet arms 21 rotate in an anticlockwise direction. Each rotation is indexed so that each pallet moves sequentially from one print head station to the next. The registration station 50 is mounted on the stator 19.

The pallet arms are secured to a rotor disc 31 driven by motor 33 programmed to rotate the disc through 45° which is one indexation. The motor 33 and its gear assembly 32 is mounted on the stator 19. As can be seen the motor is easily accessable for maintenance. The mechanism 32 may be of the same general design as the indexing mechanism disclosed in U.S. Pat. No. 4,934,263. Because the drive system for the rotor disc 31 is located at the level of the pallet arms, which are attached to the disc 31, there is no stress which was a problem with prior art machines where the indexing motor was located adjacent the base some distance below the pallet arms.

The rotor disc 31 contains a series of bushes 34 in the peripheral ring 35 of equal number to the number of pallet arms. The indexing station 41 is mounted on an arm 42 which is fixed to the central column 15 and does not rotate. The arm 42 extends from the bearing assembly 44 which does not rotate but is raised with the disc 31 when the pallet arms are raised for indexation with the print heads. Instead of pins and bushes any other suitable locating and indexing mechanism may be employed.

As the rotor reaches the end of the indexation, the pin 43 of the indexing station is urged into one of the bushes 34.

At this point the vertical pin 51 of registration station 50 is located over another bush 34 on the opposite side of the disc 31. When the rotor disc 31 and pallets are raised toward the stator 19, the pin 51 enters the bush 34 and locks the pallets into registration with the print heads.

FIG. 4 illustrates a 10 station machine with an innovation that is made possible with the present invention namely a dual purpose unload/load UL/L station which increases the number of printing/curing stations by one, to nine in this 10 station machine. If separate load and unload stations are required one of the printhead arms 23 adjacent to the UL/L station may be removed. The components of the machine are the same as those described with reference to FIGS. 1 to 3.

In FIGS. 5 and 6 an eight station stator is illustrated and the components of the machine are the same as those described with reference to FIGS. 1 to 3. The control panel 60 is located on the control panel arm 59 which in this embodiment is adjustable in elevation by means of the lever 61 and pivot point 62. Print arms with associated print heads are attachable to each of the print arm supports 23 so that 7 active print stations are available for 8 pallets. The pallet located below the control panel 60 is the load/unload station.

From the above those skilled in the art will realize that the present invention provides an inexpensive and easy to build base that provides added rigidity and stability to screen printing machines. Those skilled in the art will realize that this invention may be utilized in a number of embodiments other than those described, without departing from the core teaching of this invention.

1. A carousel screen printing machine which includes
a) a stationary column supporting a plurality of print heads
b) a rotatable carousel mounted on said column supporting a plurality of pallet support arms
c) drive means located at or above said rotatable carousel for indexed movement of said carousel about said stationary column.

2. A screen printing machine as claimed in claim 1 in which said rotatable carousel incorporates bushes which cooperate with pins at an indexing station mounted on said stationary column so that on each indexed rotation a pallet arm is located below a print arm.

3. A screen printing machine as claimed in claim 2 in which a registration mechanism is mounted on said stationary column and incorporates a pin mechanism to cooperate with one of said bushes on said rotatable carousel to register the pallet arm in a fixed position relative to a print arm.

4. A carousel screen printing machine which includes
a) a stator supporting a plurality of print heads
b) a rotor supporting a plurality of pallet support arms
c) said rotor being mounted for rotation about said stator
d) drive means for said rotor located at or above the level of said rotor
e) bushes or pins on said rotor to cooperate with complementary pins or bushes at an indexing station and at a registration station.

5. A carousel screen printing machine as claimed in claim 4 in which bushes are located in said rotor and an indexing station and a registration station are located on said stator and the indexing and registration mechanisms include pins which engage said bushes.

6. A carousel screen printing machine which includes
a) a stationary column supporting a plurality of print arms adapted to support print heads
b) a rotatable carousel mounted on said column supporting a plurality of pallet support arms
d) the carousel being arranged for indexed movement to bring each pallet arm successively into registration with each print head
e) there being one less print head than the number of pallet arms so that the pallet arm without an associated print head may be loaded or unloaded.

7. A screen printing machine as claimed in claim 6 in which a control panel is located on one print arm to replace a print head and the pallet below the control panel is the load and unload station.

8. A screen printing machine as claimed in claim 4 or 5 in which the drive means for the rotatable carousel is mounted at or above said rotatable carousel.
